(19) United States
(12) Patent Application Publication
(10) Pub. No.: US 2004/0164437 A1
(43) Pub. Date: Aug. 26, 2004

(54) Method for manufacturing a packaging web

(75) Inventor: Jurgen Morton-Finger, Weinheim (DE)

Correspondence Address: THE FIRM OF KARL F ROSS, 5676 RIVERDALE AVENUE, PO BOX 900, RIVERDALE (BRONX), NY, 10471-0900, US

(73) Assignee: MOTECH GmbH TECHNOLOGY & SYSTEMS

(21) Appl. No.: 10/764,145

(22) Filed: Jan. 23, 2004

(30) Foreign Application Priority Data
Jan. 25, 2003 (EP) 03001687.7

(51) Int. Cl. B29C 47/60; B29C 47/76

(52) U.S. Cl. 264/40.5; 264/102; 264/178 R; 264/918; 264/211.23

(57) ABSTRACT

A method for manufacturing a polyethylene terephthalate (PET) packaging web, wherein PET material is extruded using a twin-screw extruder and wherein the extruder interior space is degassed during the extrusion. The molten plastic is outputted in a strip shape from a spinning head located after the twin-screw extruder. The plastic strip is then cooled and stretched.

### FIELD OF THE INVENTION

The invention relates to a method for manufacturing a polyethylene terephthalate (PET) packaging web and, more particularly a web made from material. Basically however, virgin PET can also be used as PET material. Within the framework of the invention PET waste material means especially shredded PET waste, particularly shredded used PET bottles. The shredding produces so-called PET flakes which are preferably used in the method according to the invention.

### BACKGROUND OF THE INVENTION

PET waste material is cheaper than new PET material or new PET granules. However, PET waste material has considerable disadvantages. It is first characterized by a disadvantageously high degree of impurity and by a relatively low molecular chain length. In addition, the PET waste material has a relatively low molecular chain length. In addition, the PET waste material has a relatively high moisture content and is also present in amorphous form.

In practice it is basically known to reprocess PET waste material and especially to further process it into fibers. For this purpose, the PET waste material is initially crystallized and then dried and only then is the suitably treated waste material extruded. The crystallization and drying process can take up to eight hours so that it frequently only becomes clear after several hours whether the material is suitable for further processing. If it is found that a material batch has a poor quality, production waste is the result. In addition, the crystallization and drying is very energy-consuming and expensive.

It is basically known (EP 1 226-922 A1) to process still-moist PET material using a twin-screw extruder. The extruder interior space of this twin-screw extruder is degassed using pumps so that the moisture is removed from the PET material. Only PET granules are produced using this known method.

### OBJECT OF THE INVENTION

The object of the invention is to provide a method for manufacturing a packaging web having optimal mechanical properties and especially a high strength and excellent elasticity.

### SUMMARY OF THE INVENTION

This object is achieved with a method according to the invention which comprises the steps of manufacturing a polyethylene terephthalate packaging w b-comprising the steps of:

(a) subjecting a polyethylene terephthalate raw material to plastification in a twin-screw extruder and extruding a polyethylene terephthalate melt from the extruder;

(b) degassing an interior of the extruder during the extrusion of the polyethylene terephthalate melt therefrom;

(c) outputting a strip of the polyethylene terephthalate melt from a spinning head located downstream of the extruder; and

(d) cooling and stretching the strip of the polyethylene terephthalate to form the polyethylene terephthalate packaging web.

In the method of the invention, PET material, preferably PET waste material without pre-drying, is extruded using a twin-screw extruder.

During the extrusion the extruder interior space is degassed.

The molten plastic is outputted in a strip shape from a spinning head located downstream of the twin-screw extruder.

The plastic strip is then cooled and stretched.

In the framework of the invention PET waste material means that the material consists of at least 50 wt. %, preferably at least 80 wt. % and more preferably of at least 90 wt. % PET waste material or PET recycled material. The PET material used very preferably consists entirely of PET waste material. It is especially within the framework of the invention that the PET waste material used according to the invention originates from used PET bottles. The used PET bottles are more suitably shredded so that so-called PET flakes are formed which are preferably used within the framework of the method according to the invention. However, the PET waste material can also come from used PET film. Virgin PET can basically also be used in the method.

It is of particular importance in the method according to the invention that the PET material can be used or fed to the twin-screw extruder both without pre-crystallization and also without pre-drying.

According to a preferred embodiment, the PET waste material is fed to the twin-screw extruder using at least one metering screw. Insofar as a metering screw is mentioned here and subsequently, the term metering screw means quite generally a metering device. Preferably however, a metering screw is used as a metering device. In this way a very accurate metered addition of PET material can be achieved. The twin-screw extruder is preferably driven und rfed on a scale such that the screw walks, flights or grooves ar only 25 to 60%, preferably only 30 to 50% filled with PET material. This feeding or underfeeding of the twin-screw extruder can be effectively accomplished using the preferably used metering screw. According to a very preferred embodiment of the invention, a twin-screw extruder with extruder screws rotating in the same direction is used. In this embodiment both extruder screws of the twin-screw extruder have the same turning direction, sense or direction of rotation.

The degassing of the extruder interior space is carried out using at least one pump or vacuum pump connected to the extruder interior space. According to a preferred embodiment of the invention, the degassing takes place at least at two connection points of the extruder interior space arranged one after the other in the conveying direction.

According to a very preferred embodiment which is of quite particular importance in the framework of the invention, at least one chain lengthening substance is added to the PET material. More suitably at least one chain-lengthening substance is fed into the extruder interior space. In other words, the PET material is mixed with the chain lengthening substance in the extruder interior space. The chain-lengthening substance is preferably added after the degassing in the conveying direction in the extruder interior space. A chain-lengthening substance is also called a so-called “chain extender”. The chain-lengthening substance has the property of coupling onto the ends of the molecular chains of the PET and binding two PET molecules together. A lactam derivative and/or an oxazole derivative is preferably used as a chain-lengthening substance. According to one embodiment, a caprolactam derivative is used as a chain-lengthening substance. It is within the scope of the invention to use a lactamate as a chain-lengthening substance and carbonyl biscaprolactamate is very preferably used. According to another embodiment, an oxazolize is used as a chain-lengthening substance. Oxazolize means here an oxazoline derivative which has only one double bond. According to a preferred embodiment, 1,4-phenylene bisoxazoline can be used as a chain-lengthening substance.

It is within the scope of the invention that the PET melt leaving the twin-screw extruder is fed to the spinning head using at least one melt pump. The use of such a melt pump is assigned particular importance within the scope of the invention. It is furthermore within the scope of the invention that a sieve filter is located after the twin-screw extruder. The sieve filter is more suitably located between the twin-screw extruder and the melt pump. According to a very preferred embodiment of the invention, the melt pressure is measured before the sieve filter and after the sieve filter in the conveying direction and the metering of the PET material to the twin-screw extruder and/or the rotational speed of the twin-screw extruder is varied according to the measured pressure values. In this case, the metering of the PET material can be varied by adjusting the rotational speed of the metering screw. The pressure regulation explained previously is especially very helpful during flushing of the sieve filter. Preferably back flushing is provided and depending on the contamination of the sieve filter, melt is removed into the open in order to flush dirt from the sieve. During the flushing process additional material is additionally required from the twin-screw extruder for a short time. With the pressure regulation according to the invention this back flushing can be carried out without any problems without this resulting in any disturbing impairment of the production sequence.

It is within the scope of the invention that the plastic strip leaving the spinning head is cooled using a fluid medium, preferably in a water bath. After the cooling the plastic strip is more suitably stretched in at least one stretching device.

The invention is based on the discovery that a packaging web having surprisingly advantageous properties can be manufactured from relatively cheap PET waste using the method according to the invention. The packaging band has excellent strength and optimal elongation properties. With the method according to the invention, a packaging band which meets all the requirements can be manufactured simply, with little effort and inexpensively.

### BRIEF DESCRIPTION OF THE DRAWING

The above and other objects, features, and advantages will become more readily apparent from the following description, reference being made to the accompanying drawing in which:

FIG. 1 is a schematic diagram of a device for implementing the method according to the invention; and

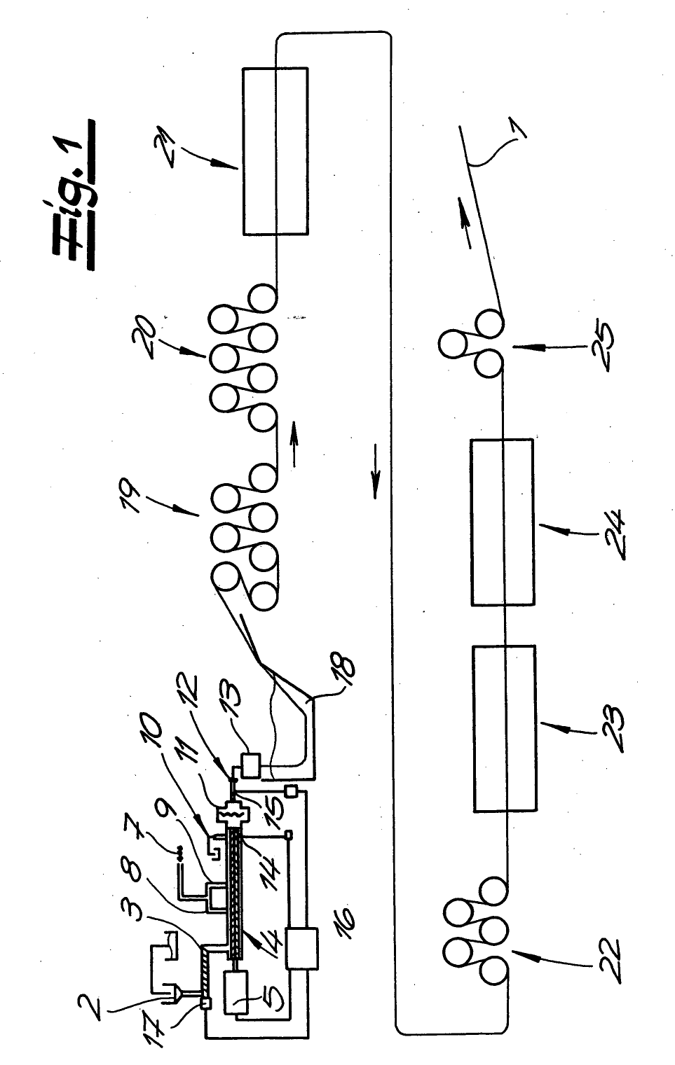

FIG. 2 is a schematic diagram showing an enlarged section from FIG. 1.

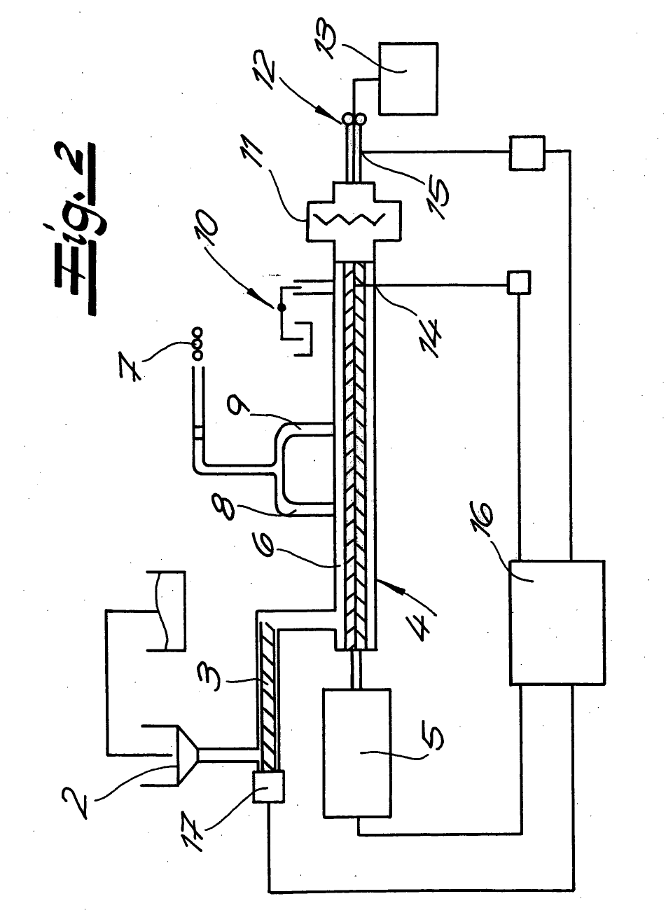

### SPECIFIC DESCRIPTION

The FIGURES show a device for implementing the method according to the invention for manufacturing a polyethylene terephthalate (PET) packaging band 1. PET waste material in the form of PET flakes 2, which were obtained by shredding used PET bottles, is supplied by means of a metering screw 3 to a twin-screw extruder 4 with which the PET waste material is extruded. In this case, the PET flakes 2 are added to the twin-screw extruder 4 in a metered fashion by the metering screw 3 on the scale that the twin-screw extruder 4 is driven underfed so that the screw walks of the two extruder screws are only around 30 to 50% filled with the PET waste material. Moreover, the twin-screw extruder 4 also has two extruder screws rotating in the same direction of rotation, which are driven by an extruder motor 5.

The extruder interior space is degassed using a vacuum pump 7. For this purpose two degassing lines 8, 9 are connected to the extruder interior space 6 one behind the other in the conveying direction of the twin-screw extruder. As a result of this degassing it is achieved that the moisture can be effectively removed from the PET waste material.

A chain-lengthening substance is added to the PET waste material or the extruder interior space 6 in a metered fashion using a metering device 10 after the degassing lines 8, 0.9 in the conveying direction. In the exemplary embodiment the chain-lengthening substance can be capronyl biscaprolactamate.

Located after the twin-screw extruder 4 is a sieve filter 11 to which a melt pump 12 is connected. The melt pump 12 supplies the PET melt to a spinning head 13 from which the PET melt emerges in a strip shape. In the exemplary embodiment the melt pressure is measured at the first measuring point 14 before the sieve filter 11 or before the melt pump 12 and at a second measuring point 15 after the sieve filter 11 or at the melt pump 12. Using a regulating device 16 the rotational speed of the twin-screw extruder 4 at the extruder motor 5 and/or the rotational speed of the metering screw 3 at the drive motor 17 of the metering screw 3 can be adjusted depending on the measured pressure values. In this way, the supply or conveyance of the plastic material can be adapted to the respective conditions in a functionally safe and efficient fashion.

The strip-shaped or web-shaped PET leaving the spinning head 13 is then passed through a water bath 18 for cooling, which has a temperature of 60° C. for example. The plastic is there more suitably guided through a first stretching device 19 which for example operates at a conveying speed of 15 m/min. In the exemplary embodiment the strip-shaped plastic is then passed through a second stretching device 20, which for example operates at a conveying speed of 60 m/min. Between the stretching devices 19 and 20 the plastic strip is stretched in the longitudinal direction or in the conveying direction. The strip-shaped plastic is then guided through a furnace 21 where it is heated and is preferably heated above the glass temperature. The plastic strip is then guided through a third stretching device 22 which operates at a conveying speed of 90 m/min for example. Between the stretching devices 20 and 22 the plastic strip is also stretched in the longitudinal direction or in the conveying direction. The strip-shaped plastic web is then guided through a fixing device 23 where the plastic web is heated. Cooling of the plastic web then takes place in the cooling device 24. The plastic web is then guided through a fourth stretching device 25 which for example operates at an operating speed of 85 m/min. The plastic web is then wound into a winding device not shown. The plastic web or plastic strip thus manufactured is exceptionally suited as packaging band.

### SPECIFIC EXAMPLE

A packaging band having a strength of 550 N/mm² and an elongation of 15% was manufactured from virgin PET material according to the prior art. A packaging band having a strength of 500 N/mm² and an elongation of 15% was obtained from pre-dried PET flakes according to the prior art. Using the method according to the invention undried PET flakes were processed to give a packaging band having a strength of 750 N/mm² and an elongation of 15%.

I claim:

1. A method of manufacturing a polyethylene terephthalate packaging web comprising the steps of:
(a) subjecting a polyethylene terephthalate raw material to plastification in a twin-screw extruder and extruding a polyethylene terephthalate melt from said extruder;
(b) degassing an interior of said extruder during the extrusion of the polyethylene terephthalate melt therefrom;
(c) outputting a strip of said polyethylene terephthalate melt from a spinning head located downstream of said extruder; and
(d) cooling and stretching said strip of said polyethylene terephthalate to form said polyethylene terephthalate packaging web.

2. The method defined in claim 1 wherein said raw material is at least in part PET flakes form by comminuting PET bottles.

3. The method defined in claim 1 wherein said raw material is supplied to said extruder with at least one metering screw.

4. The method defined in claim 3 wherein said metering screw supplied said raw material to said extruder such that flights of the extruder screws are filled only to 25% to 60% with the polyethylene terephthalate raw material.

5. The method defined in claim 4 wherein the flights of the extruder screws are filled to 30% to 50% with the polyethylene terephthalate raw material.

6. The method defined in claim 1 wherein the screws of the extruder are driven in the same sense.

7. The method defined in claim 1 wherein the interior of said extruder is degassed by connecting at least one suction pump thereto.

8. The method defined in claim 1, further comprising the step of feeding at least one chain-lengthening substance to said interior of said extruder.

9. The method defined in claim 8 wherein said chain-lengthening substance is a lactam or an oxazole derivative.

10. The method defined in claim 1, further comprising the steps of:
passing said melt through a sieve filter;
measuring melt pressure up flights of the extruder screws are filled only to 25% to 60% with the polyethylene terephthalate raw material stream and downstream of said sieve filter; and
controlling a rotary speed of the screws of said extruder in accordance with the measured melt pressures.

11. The method defined in claim 1 wherein said melt is fed to said head with at least one melt pump.

12. The method defined in claim 1 wherein said strip is cooled in a liquid.

13. Th method defined in claim 12 wherein said liquid is a water bath.
